(19) United States
(12) Patent Application Publication
(10) Pub. No.: US 2016/0003524 A1
(43) Pub. Date: Jan. 7, 2016

(54) SYSTEM AND METHOD FOR STORAGE AND DELIVERY OF CRYOGENIC LIQUID AIR

(71) Applicant: BCS Life Support, LLC, Deland, FL (US)

(72) Inventor: Clayton E. Blalock, New Smyrna Beach, FL (US)

(21) Appl. No.: 14/859,618

(22) Filed: Sep. 21, 2015

Related U.S. Application Data
(63) Continuation of application No. 13/440,006, filed on Apr. 5, 2012.
(60) Provisional application No. 61/471,768, filed on Apr. 5, 2011.

(51) Int. Cl. F25J 1/00; F17C 7/04

(52) U.S. Cl. CPC F25J 1/0012; F17C 7/04; F25J 2210/90; F17C 2221/031; F17C 2227/0107

(57) ABSTRACT

One aspect of the disclosure provides a system for storing a cryogenic mixture of liquid air and providing a source of breathable air. In an embodiment, the system comprises an insulated storage vessel, a cryocooler, and a vaporizing unit. The insulated storage vessel contains a cryogenic mixture of liquid air comprising liquid nitrogen (LN₂) and liquid oxygen (LO₂) The cryocooler is mounted to an exterior of the storage vessel to condense liquid air that vaporizes within the storage vessel, thereby returning the vaporized liquid air to a liquid phase such that concentrations of the LN₂ and LO₂ in the cryogenic mixture remain approximately constant. The vaporizing unit is external of the storage vessel and is in fluid communication with an interior of the storage vessel. Liquid air from the interior of the storage vessel passes through, vaporizes, and exits the vaporizing unit as the breathable air.

### CROSS-REFERENCE TO RELATED APPLICATION

This application is a continuation of U.S. application Ser. No. 13/440,006 filed on Apr. 5, 2012, entitled “System and Method for Storage and Delivery of Cryogenic Liquid Air”, which claims the benefit of U.S. Provisional Application Ser. No. 61/471,768 filed by Clayton E. Blalock on Apr. 5, 2011 which both are commonly assigned and are incorporated herein by reference in their entirety.

### BACKGROUND OF THE INVENTION

The present invention relates to the storage and use of cryogenic liquids. More specifically, the invention pertains to systems and methods used for the storage and use of a cryogenic mixture of liquid nitrogen and liquid oxygen.

Some United States government agencies utilize sub-critical liquid air backpacks rather than standard self-contained breathing apparatuses (“SCBA”) to perform work in hazardous atmospheres. These liquid air backpacks include a cryogenic mixture of about 21% liquid oxygen (“LO₂”) and 79% liquid nitrogen (“LN₂”) as a source of breathable air. Because a system or method for storing bulk quantities of liquid air is not available, a cryogenic mixture of liquid air (up to 4,000 gallons at times) is manufactured within a known time period prior to performing a task that requires the use of the liquid air backpack. A liquid air supplied backpack used in a protective suit provides a source of breathable air for up to about two hours.

In comparison, a standard SCBA, used by first responders (firefighters etc.), utilizes a cylinder filled with compressed air and supplies breathable air for only one hour. Typically, the air supply in such suits will last only about thirty-five to forty minutes because the rate at which the air is consumed is dependent upon the demand. A responder, such as a firefighter, that is under stress will consume the air supply at a higher rate as compared to consumption of air under normal conditions.

Storage of multi-component cryogens is difficult, due to disproportionate boil-off rates of the components. Liquid nitrogen boils at −320° F., LO₂ boils at −297° F., and liquid air has a boiling point of −317° F. Since even the best insulated vessels allow some heat leak, and since LN₂ has a lower boiling point of the two components, the liquid nitrogen will tend to boil more rapidly. This excessive LN₂ boil-off results in oxygen enrichment of the stored liquid, as the nitrogen-rich vapor vents to atmosphere. Venting is necessary to prevent an overpressure of the storage vessel, or Dewar. As the more volatile nitrogen boils and is vented, the O₂/N₂ ratio changes. Ultimately, this increased oxygen content will render “life support grade” breathing air as an unusable fire hazard. Presently, bulk amounts of liquid air are stored for only up to about two weeks at which time any remaining liquid air must be discarded.

Zero-loss systems have been used to store liquid oxygen in bulk amounts. Such a system is illustrated in FIG. 1, and includes a vacuum insulated vessel 10 in which LO₂ is stored. An external source of LN₂ is maintained in a second vessel 11 and is routed through a pipe 12 through the ullage space 13 of vessel 10. As LO₂ vaporizes, as a result of the vessel 10 heat leak, the O₂ vapor condenses on the pipe 12 thereby returning the vapor to liquid phase. The pipe 10 may be configured to wind back and forth in the ullage space above the LO₂ to increase the condensing surface area and thereby increase the amount of vapor condensed. In addition, one or more valves disposed between the first vessel 10 and second vessel 11 may be automated to open when the vapor pressure in vessel 10 reaches a predetermined upper limit, and close when the pressure is reduced to a predetermined lower limit.

The manufacture of liquid oxygen in air separation plants inherently produces a small amount of methane contaminants. In this case, boil-off of the LO₂ will result in methane enrichment. If the methane concentration is too high the LO₂ cannot be used for some applications. Accordingly, the O₂ vapor in the ullage space of the vessel 10 is condensed to maintain the liquid oxygen to methane ratio. However, such a system has never been used for storage of liquid air.

Systems and methods for storing liquid air are disclosed in various patents including, but not limited U.S. Pat. Nos. 3,260,060; 5,571,231; and, 5,778,680. Generally, these patents disclose a cryogenic mixture of LN₂ and LO₂ stored in a vessel that is adapted to condense the vapor in the ullage space of the vessel. The liquid air is drawn from the bottom of the vessel and re-circulated in a pipe disposed in the ullage space of the storage vessel to condense the vapor and return it to its liquid phase. However, such systems may not work well for storage of bulk amounts of liquid air because the temperature difference between the liquid air and vapor may be nominal. These systems may not condense a sufficient amount of vapor over an extended time period to maintain the appropriate concentrations of LN₂ and LO₂ to serve as a source of breathable air.

Inasmuch as disasters, especially manmade disasters such as a biological, chemical or radiological disaster, may occur without warning, the first responder's reaction time to the disaster is critical. First responders will not be able to wait for a cryogenic mixture of liquid air to be created.

In addition, when a catastrophic event (chemical, biological, radiological, or nuclear) takes place within a city, people in occupied buildings are instructed to respond in the following manner: Close, then seal all windows and doors, turn off HVAC systems, evacuate to a safe haven, or secure space within the building, if provided, stay inside and wait for help to arrive. This could be a long wait, depending on the nature and size of the event.

Refuge chambers placed within a mine are designed to keep as many as twenty miners alive for ninety-six hours, following a major mine emergency, until rescuers arrive. Oxygen requirements for that many people are enormous, much more than can be provided by compressed air cylinders in the limited amount of space these chambers afford. Present art allows the use of compressed oxygen cylinders to be used for the sole air supply within the chamber. Mine refuge chambers currently utilize high-pressure compressed oxygen cylinders as the breathing supply within the sealed, self-contained space. Oxygen is discharged into the chamber at the approximate rate that 20 miners at rest would require. Exhaled carbon dioxide is removed by scrubbing, through lithium hydroxide canisters, or some other chemical means. However, the use of compressed oxygen within a confined space is less-than-desirable, due to the increased fire hazard, but is deemed the only possible way to provide adequate oxygen to that many people for that duration.

M113 Armored Personnel Carriers are examples of military vehicles that employ air purification systems referred to as NBC Systems. The NBC system provides a filter unit and gas masks for protection against Nuclear, Biological, and Chemical attacks. The NBC system will not filter carbon monoxide exhaust gases, nor will the air purifier provide oxygen to protect against asphyxiation. Carriers may be equipped differently. All of the NBC systems consist of an air purifier, hose assemblies to carry purified air to the gas masks, a circuit breaker, switch, and electric cables. In addition to the basic M8A3 NBC system, the M13 NBC system adds heaters to heat the purified air in cold weather, and the M14 NBC system provides hospital hood protectors for disabled patients. The M14 may also have heaters. However, such systems suffer from the same draw backs as identified above; namely, the systems are not available for storing bulk amounts of liquid air for extended periods of time.

Accordingly, a need exists for a system and method for storing a cryogenic mixture of liquid air for an extended period of time for the purpose of making readily available to first responders a supply of liquid air to be used as an emergency response breathing supply. However, the system and method are not limited for use by first responders and may be included for any use that requires the storage of liquid air for an extended period of time. For example, the present invention may be used in refuge chambers or safe havens in mines, in buildings for providing air to people inside the building during a catastrophic event or in first responder vehicles as a source of air for the responders.

### SUMMARY

One aspect of the disclosure provides a system for storing a cryogenic mixture of liquid air and providing a source of breathable air. In an embodiment, the system comprises an insulated storage vessel, a cryocooler, and a vaporizing unit. The insulated storage vessel contains a cryogenic mixture of liquid air comprising liquid nitrogen (LN₂) and liquid oxygen (LO₂) The cryocooler is mounted to an exterior of the storage vessel to condense liquid air that vaporizes within the storage vessel, thereby returning the vaporized liquid air to a liquid phase such that concentrations of the LN₂ and LO₂ in the cryogenic mixture remain approximately constant. Returning the vaporized liquid air to the liquid phase also reduces pressure in the storage vessel within a predetermined pressure range. The vaporizing unit is external of the storage vessel and is in fluid communication with an interior of the storage vessel. Liquid air from the interior of the storage vessel passes through, vaporizes, and exits the vaporizing unit as the breathable air.

Another aspect of the disclosure provides a method of storing a cryogenic mixture of liquid air and providing a source of breathable air. In one embodiment, the method comprises filling an insulated storage vessel with the cryogenic mixture of liquid air where the cryogenic mixture of liquid air comprises liquid nitrogen (LN₂) and liquid oxygen (LO₂). In the embodiment, the method further comprises condensing liquid air that vaporizes within the storage vessel with a cryocooler mounted to an exterior of the storage vessel thereby returning the vaporized liquid air to a liquid phase such that concentrations of the LN₂ and LO₂ remain approximately constant. The returning of the vaporized liquid air to the liquid phase also reduces pressure in the storage vessel within a predetermined range. In the embodiment, the method further comprises vaporizing liquid air in a vaporizing unit external of the storage vessel and in fluid communication with an interior of the storage vessel by passing the liquid air from the interior of the storage vessel through the vaporizing unit. The vaporized liquid air exits the vaporizing unit forming the breathable air.

### BRIEF DESCRIPTION OF THE DRAWINGS

FIG. 1 is a schematic view of a prior art system for storing liquid oxygen.

FIG. 2 is a schematic view of a first embodiment of the invention.

FIG. 3 is a schematic view of a second embodiment of the invention.

FIG. 4 is a schematic drawing of a system of the present invention that circulates liquid air through a pump and pipe to the ullage space of storage vessel.

FIG. 5 is a schematic drawing of an embodiment of the invention including a refuge chamber for a mine.

FIG. 6 is a schematic drawing of an embodiment of the invention including a building emergency air system.

FIG. 7 is a schematic drawing of an embodiment of the invention including a refuge chamber for a mine.

FIG. 8 is a schematic drawing of an embodiment of the invention including a vehicle emergency air system.

### DETAILED DESCRIPTION OF THE INVENTION

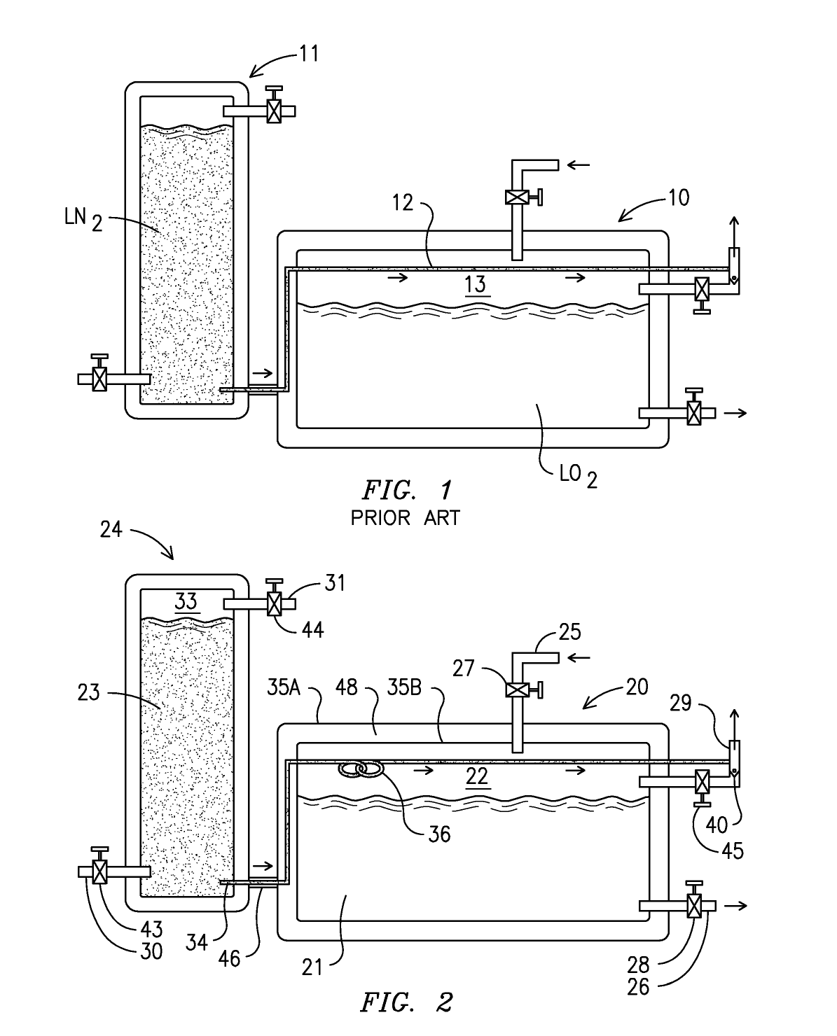

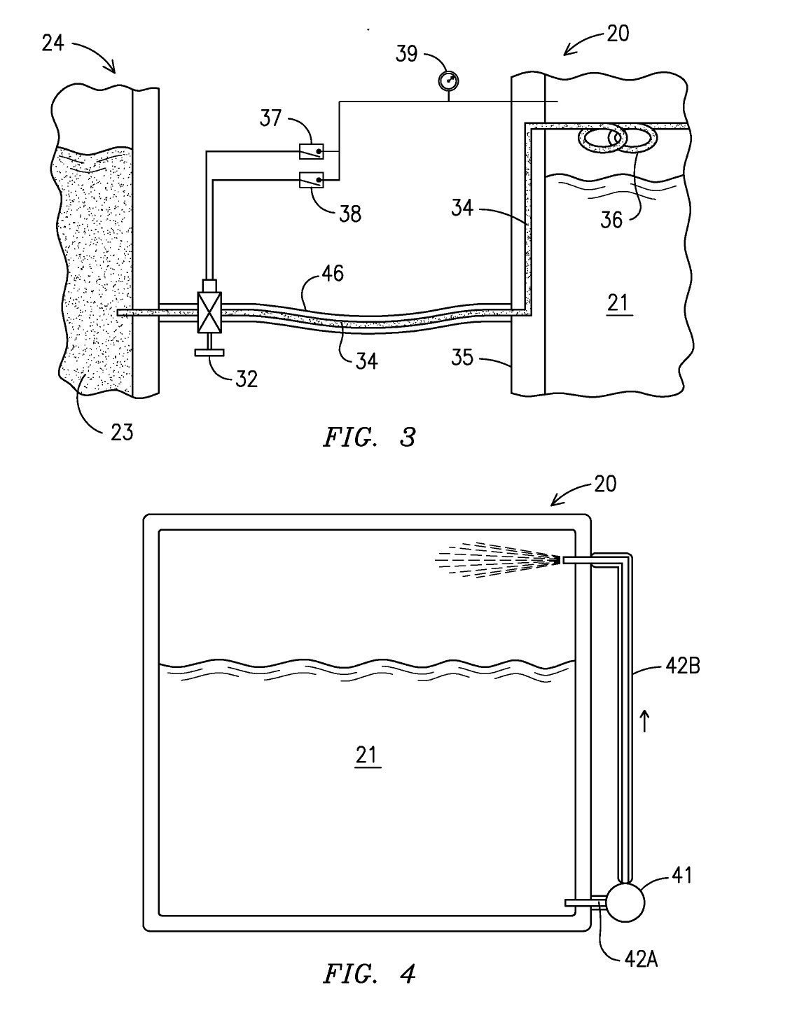

An embodiment for the present invention shown in FIGS. 2 and 3 utilizes a first storage vessel 20 in which a cryogenic mixture 21 of liquid nitrogen (LN₂) and liquid oxygen (LO₂) is stored. The mixture 21 may comprise about twenty percent (20%) LO₂ by volume and about eighty percent (80%) LN₂ by volume so that it may serve as a source of breathable for example in use with a self-contained breathing apparatus (“SCBA”); however, the concentrations may vary. Known safety standards for using a cryogenic mixture as a source of breathable include concentrations of LN₂ ranging from to about 76.5% to about 81.5% by volume of LN₂, and concentrations of LO₂ ranging from about 19.5% to about 23.5% by volume of LO₂. Such a mixture 21 may be stored at a pressure of about 40 pounds per square inch absolute (psia) at −300.01° F. to about 55 psia at −293.30° F.

The first vessel 20 includes an inlet/fill pipe 25 for providing the cryogenic mixture 21 therein and an outlet pipe 26 for providing the mixture 21 to a user. Control valves 27 and 28 control the flow of the mixture 21 in and out of the pipes 25 and 26 respectively. In addition, a vent pipe 29 is positioned on the first vessel 20 in communication with an ullage space or headspace 22 above the mixture 21 to vent gases to maintain the pressure in the vessel 20 within a predetermined pressure range. The vent pipe 29 may be opened and closed via flow control valve 45. However, this vent pipe 29 may be used minimally in the present system as condensing liquid air vapor in the ullage space 22 of the first vessel 20 can reduce the vapor pressure.

The vessel 20 is a Dewar that is vacuum insulated. That is, the vessel 20 includes spaced apart double walls 35A and 35B with a vacuum 48 disposed there between for insulation of contents of the vessel 20. Despite the insulation of the vessel 20, there will exist some level of heat leak that will cause the mixture 21, or components thereof to evaporate to the ullage space (or head space) 22 above the cryogenic mixture 21.

Accordingly, a refrigerant 23 supplied via an external source, relative to the cryogenic mixture 21 in the vessel 20, is piped through the ullage space 22 of the first storage vessel 20 to condense the evaporated liquid air in the ullage space to the liquid phase. In an embodiment, the refrigerant 23 is liquid nitrogen that is stored in a second storage vessel 24. The LN₂ is preferably stored under pressure at about 20 psia at a temperature of about −315.55° F. The second vessel 24 includes an inlet/fill pipe 30 for providing the LN₂ therein and a vent pipe 31 that vents nitrogen vapor from an ullage space 33 of the second vessel 24. Control valves 43 and 44 control the flow of the liquid nitrogen into the vessel 24 and evaporated nitrogen out of the vessel 24 respectively.

With respect to FIG. 2, the LN₂ flows from the second vessel 24 through the first vessel 20 via a pipe 34. Thus the pipe 34 is in fluid flow communication with an interior of the second vessel 24 and LN₂ stored therein. That portion of the pipe 34 that extends from the second vessel 24 to the ullage space 22 of the first vessel 20 is preferably insulated in some fashion. In an embodiment shown in FIG. 2, the pipe 34 may include a vacuum insulated jacket 46, or have some other insulation mechanism, surrounding that portion of the pipe 34 disposed between the first vessel 20 and the second vessel 24. The pipe 34 is routed vertically through the vacuum insulated wall 35 of the vessel 20 for insulation of the pipe 34.

The pipe 34 may be positioned with respect to the first vessel 20 and second vessel, so the pipe 34 directly feeds from the second vessel 24 to the ullage space 22 of the first vessel 20 without routing the pipe through the vessel wall 35. However, with larger vessels having a storing capacity of 1,000 gallons, a stored liquid is typically drawn from the bottom of a vessel, so the pipe 34 may have to be routed vertically to reach the ullage space 22, and insulated accordingly. It may be that the second vessel 24 can be elevated with respect to the first vessel 20, so the bottom of second vessel 24 is aligned relative to the ullage space 22 so the pipe 34 can be fed directly into the ullage space 22 without the above-described routing.

With respect to FIGS. 2 and 3, the pipe 34 may have a cooling coil 36 (or heat exchanger) to increase the surface of the pipe 34 within the ullage space 22 in order to capture more vapor for more efficient condensation. The pipe 34 may have other configurations such as space 22 may fabricated from known materials such as stainless steel or copper. That portion of the pipe 34 disposed between first vessel 20 and second vessel 24 may be similarly composed of an insulated stainless steel or copper. Alternatively, the pipe 34 may include a vacuum insulated flex pipe or line as shown in FIG. 3.

The LN₂ is supplied through the pipe 34 on an as needed basis. More specifically, if the pressure within the first vessel 20 reaches, approaches or surpasses a predetermined upper pressure limit, the LN₂ is supplied through the pipe 34 until the pressure within the first vessel 20 reaches a predetermined lower pressure limit, or falls within an accepted pressure range. With respect to FIG. 3, a valve system including a solenoid 32 is positioned in communication with the pipe 34. A first switch 37 and second switch 38, preferably pressure switches, are placed in communication with a pressure gauge 39 that monitors the pressure within the first vessel 20 and in communication with the solenoid valve 32. The first switch 37 is activated to open the valve 32 when the pressure gauge 39 detects/measures a pressure within vessel 20 that reaches, approaches or exceeds a predetermined upper pressure level. When LN₂ flows through the pipe 34, and in particular through that portion of the pipe 34 that is disposed with the ullage space 22, liquid air vapor, and/or its vapor components nitrogen and oxygen, will condense on the pipe 34 returning to liquid phase in the vessel. In this manner concentration of LN₂ and LO₂ are maintained at acceptable levels relative to one another to store liquid air for extended periods of time as a source for breathable air.

As shown in FIG. 2, the pipe 34 exits the vessel 20 through walls 35 and is in fluid communication with the vent pipe 29. As the LN₂ passes through the pipe 34 the heat exchange that takes place between the pipe 34, LN₂ and air vapor in the ullage space 22 causes the LN₂ to vaporize into nitrogen gas, which is released through the vent pipe 29. A check valve 40 is preferable mounted in the vent pipe 29 between the wall 35 of vessel 29 and the point of entry of the pipe 34 and nitrogen relative to the vent pipe 29 to prevent a back flow of nitrogen into the vessel 20. Backflow of the nitrogen into the vessel should be avoided in order to maintain the relative concentrations of the liquid air 21 components.

In another embodiment shown in FIG. 4, a pump 41 and re-circulating pipe, including inlet 42A (with respect to the pump) and outlet pipe 42B (with respect to the pump 41) may be added to the system to avoid stratification of the liquid air mixture. More specifically, it is thought that over time the LN₂ and LO₂ may separate and stratify. Liquid oxygen is denser than LN₂ and would separate toward a bottom of the vessel 20, while the LN₂ migrate above the LO₂. To avoid this potential problem a pump 41 is positioned in fluid communication with a bottom end of the vessel 20. The pump 41 may be a typical centrifugal pump sized according to the size of the vessel. For example, for a 1,000-gallon vessel, a pump that is capable of drawing 5 gallons per minute of liquid air may be sufficient; and, for larger vessels, such as 4,000 gallon to 6,000 gallon vessels, the pump may be capable of drawing 30 gallons per minute of liquid air.

In this manner, the pump 41 draws the liquid air from the bottom of the vessel 20 and re-circulates the liquid into the vessel 20 through pipe 42B, by injecting the liquid into the ullage space 22. A spray nozzle (not shown) may be disposed on an end of the pipe 42B to inject the liquid air into the ullage space 22. In this manner, the liquid air 21 may be circulated to prevent stratification of the mixture's components, LN₂ and LO₂. In addition, the injection of the liquid air 21 into ullage space 22 may provide some immediate pressure relief because the temperature of the liquid air 21 is lower than the temperature within the vessel 10 at the ullage space 22. The pump 41 may draw the liquid air 21 continuously or at timed intervals as determined by a user. For example, the pump 41 may linked with pressure switches 37, 38, so that the pump is activated when the pressure within the first storage vessel 20 approaches, reaches or exceeds a pressure limit. In this manner, the liquid air 21 is injected into the ullage space 22 while the refrigerant 23 flows through the heat exchanger 36, aiding the refrigerant 23 in reducing the pressure within the first vessel 20, which may decrease the amount of time the LN₂ refrigerant is needed. When the pressure within the first storage vessel reaches or falls below the pressure limit, then the pump is deactivated.

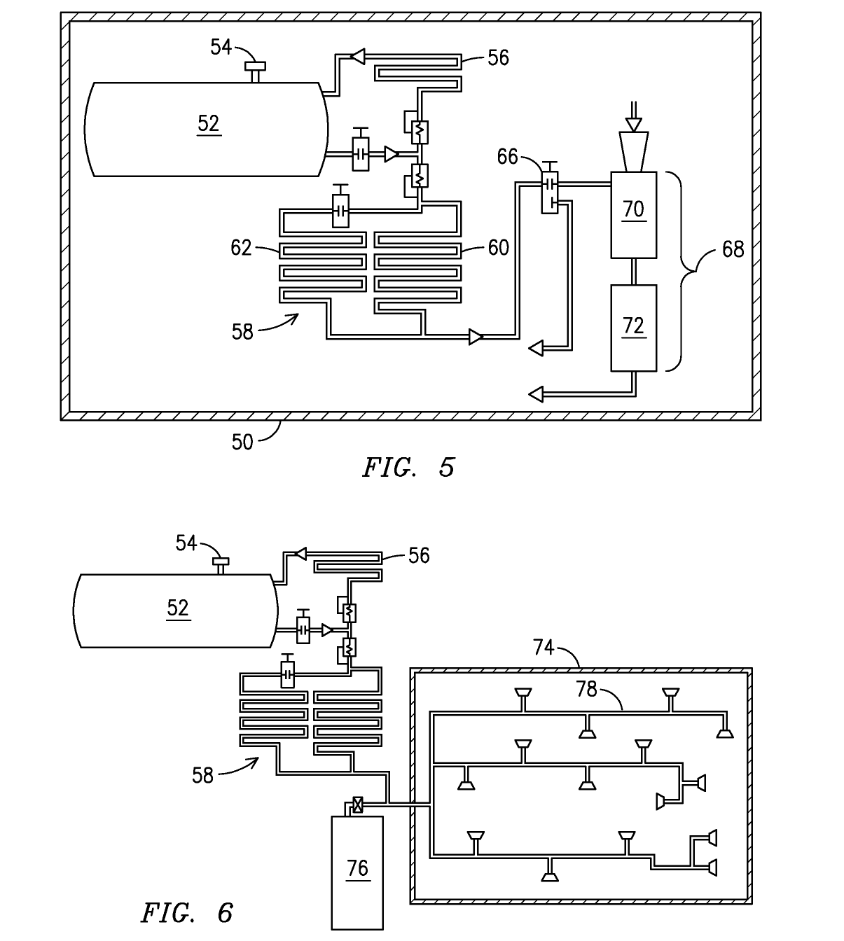

The refuge chamber liquid air breathing system shown in FIG. 5 may replace the compressed oxygen storage and delivery system, related plumbing and components, with a cryogenic air supply system consisting of: (a) storage Dewar (b) cryocooler, to effect zero-loss storage (c) Dewar regulated pressure-building circuit; and, (d) vaporizing heat exchanger. As shown in FIG. 5, a liquid air storage Dewar 52 is provided with a cryocooler 54 in a safety or safe haven chamber 50 formed in a mine. The term cryocooler has used herein may be may include those systems known to those skilled in the art that included oscillating (pulse tube), acoustic or mechanical (piston pump) cryocooler systems that effect heat exchange and result in condensation of vaporized in the storage vessel. Cryocoolers sold by Cryomech, Inc. located in Syracuse, N.Y., may work with the subject invention for storage of liquid air. For example, the Gifford-McMahon AL25 cryocooler sold by Cryomech, Inc. and equipped with a cold head and compressor may be used with the subject invention.

A vaporizing heat exchanger or vaporizing unit 58 is provided so external of the Dewar 52 and in fluid communication with an interior of the Dewar 52. The vaporizing head exchanger may simply include a coiled pipe. In an embodiment, the vaporizing heat exchanger 58 may include a first section 60 in fluid communication with a second section 62. A selector valve 64 is disposed between the two sections 60, 58 to control flow of the liquid air through one or both sections. If the valve is closed the liquid air will be vaporized in the first section 60 and may exit the vaporizer at a cooler temperature than if flowing through both sections 60, 62. However, if the selector valve 64 is open the liquid air or gaseous air will flow through both sections causing the flow rate to slow so the air exiting the exchanger 58 is warmer. The first section 60 may be selected during warmer months of the year to provide some cooling, while both sections 60, 62 may be selected for cooler months of the year.

The system shown in FIG. 5 may also include a re-pressurizing circuit 56 as described above, in which liquid air is pumped from the Dewar 52 and injected into a ullage space to reduce pressure in the Dewar 52. To the extent vaporization of liquid air may take place within the Dewar 52, pressure within the Dewar 52 may reach or rise above a predetermined limit liquid air is circulated through the circuit. A pressure sensor (not shown) and controller may be provided to detect pressure within Dewar 52 and open valve or regulator 66 for circulation of the liquid air.

The refuge chamber liquid air breathing system Dewar will be filled with LAir prior to being placed in the mine, and then remain in a static/full condition during normal mine operations. Electrical mine power is supplied to the cryocooler, enabling the Liquid Air in the Dewar to be stored in a zero-loss condition. In the event of an emergency, miners will enter the chamber and open the Vaporizer Supply Valve, activating the system. Liquid cryogen flows into the vaporizer at a predetermined rate to deliver the prescribed amount of airflow into the chamber, and at the desired temperature. Since the breathing air originates as a cryogen, temperature control capabilities are retained. This is important because over-heating in the chamber presents a problem. This system will provide 96 hours of breathing air, and cooling to trapped miners until rescue arrives. It is estimated that 64 gallons of liquid air may serve to provide ten people with breathable air for 96 hours, if the flow rate of the liquid air is maintained at 66 ft3 per hour.

In addition, the system may include a scrubber 68 that removes carbon dioxide from the used-air in the room. As illustrated a vortex 70 is provided in fluid communication with a lithium hydroxide source 72. The vortex 70 draws air from the chamber at a low volume rate and directs the air the LiOH source to remove CO2 from the air.

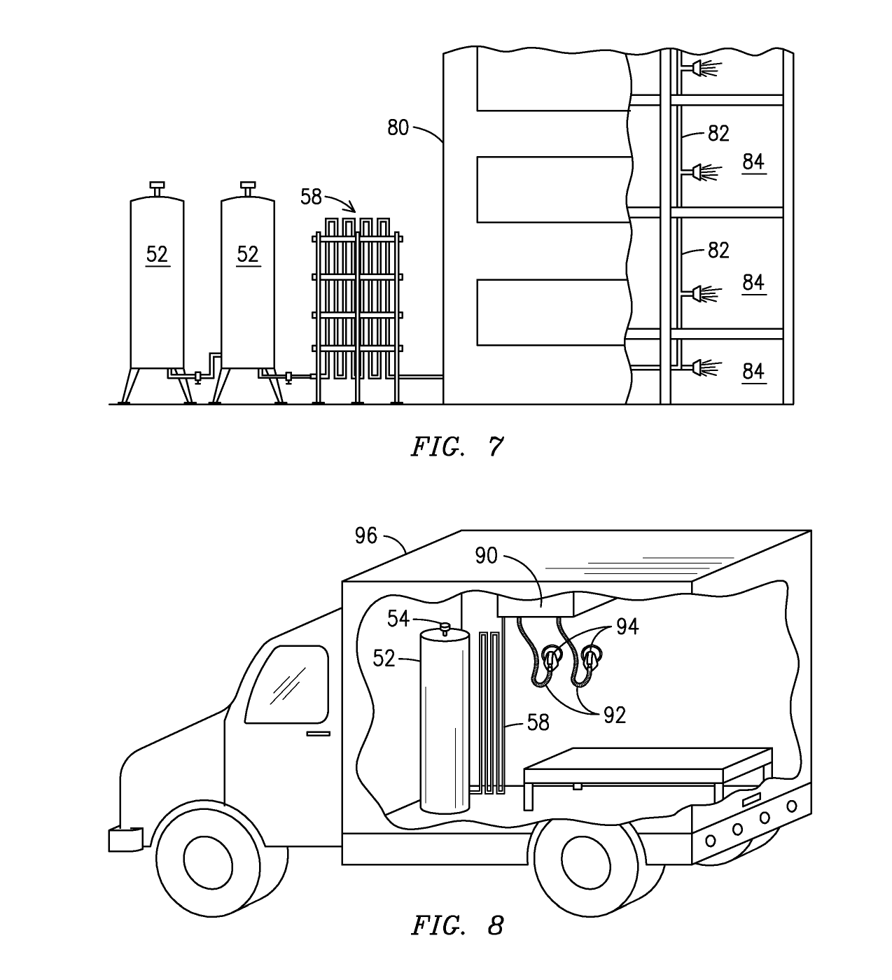

In other embodiments shown in FIGS. 6 and 7, the system and method for storing a cryogenic liquid is incorporated in a building emergency air system. Such a system may work in the same manner as the above described mine refuge chamber 50, and may include a cryocooler or a source of liquid nitrogen to store the liquid air. As shown in FIGS. 6 and 7, the cryogenic storage system may be piped into a buildings HVAC system 76 or may include a dedicated duct and ventilation system 78. When an emergency occurs, the building's HVAC system is isolated, and the emergency building system is activated, introducing pure air through the existing ductwork 78 (FIG. 6), placing, and maintaining the entire facility 74 under positive pressure, reducing contaminant intrusion. Alternatively, the air is delivered through dedicated piping or ductwork 82, to “secure spaces” or isolated rooms 84 within the facility or building 80 (FIG. 7). Since the supplied air originates as a cryogen, temperature control capabilities are retained.

The building emergency air system would work as follows: When notification is received concerning a breathing hazard in the vicinity, i.e., chemical, biological, or radiological, the system is activated. Activation may be accomplished by initiating a programmable logic controller, throwing a switch, or manually, by pulling a lever or opening a valve, and can also be triggered by toxic gas and vapor detectors. Simultaneously, the HVAC system 76 is disabled; motor controlled valves isolate the HVAC ductwork 78, and then open the liquid air supply from the storage Dewar 52 to the vaporizer or heat exchange unit 58, thus initiating the flow of breathing air into the ductwork 78, 82. Air can be delivered in this fashion to place an entire building under positive pressure, or ducted directly into a building “safe haven.” A “safe haven,” or “secure space” is a dedicated room, usually located in the center of the building, set up for the purpose of providing food, water, and air to the building occupants, in the event of a catastrophe. Multi-story buildings would have a secure space on each floor. The building emergency air system can be customized to provide protection to occupants of all types and sizes of buildings.

In another embodiment, the system and method of storing a cryogenic liquid may be used as a vehicle emergency air system. In such a system liquid air is stored in a Dewar 52 mounted on, or within the vehicle 96 (FIG. 8). The Liquid Air is converted to breathable air in a vaporizer/warm-up coil 58, and is then delivered to the occupants through a manifold 90, with connected hoses 92 and masks 94. Cryogenic air, manufactured from Liquid Oxygen, and Liquid Nitrogen is free from all impurities, so there is no need for filtration. The system can be adapted to suit any conveyance that might have a need for an emergency breathing supply, i.e., ground vehicle, submarine, ship, or aircraft. A cryocooler or a liquid nitrogen source may be used a condenser that is suspended in the headspace of the Dewar to store the liquid air under a “zero-loss” condition.

In addition to the above described embodiments, the system and method for storing a cryogenic mixture may be incorporating as an emergency air supply to hospitals. More specifically, the system may be linked with a hospital's oxygen support system in order to provide air to devices such as ventilators, incubators, etc. In case of an emergency, the conduits directing oxygen to such devices is closed and isolated, so that air is then piped in from the cryogenic storage unit.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A system for storing a cryogenic mixture of liquid air and providing a source of breathable air, comprising:
an insulted storage vessel containing a cryogenic mixture of liquid air comprising liquid nitrogen (LN₂) and liquid oxygen (LO₂);
a cryocooler mounted to an exterior of said storage vessel to condense liquid air that vaporizes within said storage vessel thereby returning said vaporized liquid air to a liquid phase such that concentrations of said LN₂ and LO₂ in the cryogenic mixture remain approximately constant, said returning said vaporized liquid air to said liquid phase also reducing pressure in said storage vessel within a predetermined pressure range; and
a vaporizing unit, external of said storage vessel in fluid communication with an interior of said storage vessel, and in which said liquid air from said interior of said storage vessel passes through, vaporizes, and exits said vaporizing unit as said breathable air.

2. The system of claim 1, wherein said cryogenic mixture of said liquid air may comprise about 79% of said LN₂ and about 21% of said LO₂.

3. The system of claim 1, wherein said cryogenic mixture of said liquid air may include concentrations ranging from about 76.5% to about 81.5% by volume of said LN₂ and concentrations ranging from about 19.5% to about 23.5% by volume of said LO₂.

4. The system of claim 1, wherein said cryogenic mixture of said liquid air may be stored in said storage vessel at a pressure of about 40 pounds per square inch absolute (psia) at a temperature of 300.01° F. to about 55 psia at a temperature of −293.30° F.

5. The system of claim 1, wherein said vaporizing unit includes a first section in fluid communication with a second section.

6. The system of claim 5, further comprising a selector valve operable to allow said liquid air passing through said vaporizing unit to only pass through said first section or both said first and second sections.

7. The system of claim 5, wherein said vaporizing unit further includes a re-pressurizing circuit which allows said vaporized liquid air exiting said vaporizing unit to return, by the opening of a valve, to an ullage space in said storage vessel when a pressure within said storage vessel exceeds said predetermined pressure range.

8. The system of claim 1, further comprising a scrubber to remove CO₂ from human exhalation gases in a room where said system operates.

9. A method of storing a cryogenic mixture of liquid air and providing a source of breathable air, comprising:
filling an insulated storage vessel with said cryogenic mixture of liquid air, said cryogenic mixture of liquid air comprising liquid nitrogen (LN₂) and liquid oxygen (LO₂);
condensing liquid air that vaporizes within said storage vessel with a cryocooler mounted to an exterior of said storage vessel thereby returning said vaporized liquid air to a liquid phase such that concentrations of said LN₂ and LO₂ remain approximately constant, said returning said vaporized liquid air to said liquid phase also reducing pressure in said storage vessel within a predetermined range; and
vaporizing liquid air in a vaporizing unit external of said storage vessel and in fluid communication with an interior of said storage vessel by passing said liquid air from said interior of said storage vessel through said vaporizing unit, said vaporized liquid air exiting said vaporizing unit forming said breathable air.

10. The method of claim 9, wherein said cryogenic mixture of said liquid air may comprise about 79% of said LN₂ and about 21% of said LO₂.

11. The method of claim 9, wherein said cryogenic mixture of said liquid air may include concentrations ranging from about 76.5% to about 81.5% by volume of said LN₂ and concentrations ranging from about 19.5% to about 23.5% by volume of said LO₂.

12. The method of claim 9, wherein said cryogenic mixture of said liquid air may be stored in said storage vessel at a pressure of about 40 pounds per square inch absolute (psia) at a temperature of 300.01° F. to about 55 psia at a temperature of −293.30° F.

13. The method of claim 9, wherein in said vaporizing unit includes a first section in fluid communication with a second section.

14. The method of claim 13, further comprising selecting, with a selector valve, either said first section or both said first and second sections for passage of said liquid air passing in said vaporizing unit.

15. The method of claim 13, further comprising allowing said vaporized liquid air exiting said vaporizing unit to return, by the opening of a valve, to an ullage space in said storage vessel when a pressure within said storage vessel exceeds said predetermined pressure range.

16. The method of claims 9, further comprising removing, using a scrubber, CO₂ from human exhalation gases in a room where said insulated storage vessel operates.
